(19) United States
(12) Patent Application Publication
(10) Pub. No.: US 2001/0049879 A1
(43) Pub. Date: Dec. 13, 2001

(54) Laser level and square

(76) Inventor: Robert W. Moore JR., Woodstock, GA (US)

Correspondence Address: GARDNER GROFF MEHRMAN & JOSEPHIC, P.C., PAPER MILL VILLAGE, BUILDING 23, 600 VILLAGE TRACE, SUITE 300, MARIETTA, GA, 30067, US

(21) Appl. No.: 09/754,757

(22) Filed: Jan. 4, 2001

Related U.S. Application Data
(60) Provisional application No. 60/174,633, filed on Jan. 5, 2000.

(51) Int. Cl. G01C 9/00

(52) U.S. Cl. 33/376

(57) ABSTRACT

A portable level and square laser alignment tool comprising a base and a separable L-shaped square. The base serves as an adjustable mounting surface upon which the L-shaped square is removably secured via a dual cam mechanism. The L-shaped square comprises two legs positioned at ninety degrees from each other thereby serving as a square to draw and/or test inside or outside right angles. Carried on each leg is a bubble level for providing a means to level the L-shaped square and/or the base. Additionally, a battery powered laser is attached to and is positioned in-line with each leg. The L-shaped square can be utilized alone or in conjunction with the base.

### CROSS REFERENCE TO RELATED APPLICATION

The present non-provisional patent application claims priority of U.S. Provisional Application Serial No. 60/174,633, filed on Jan. 5, 2000.

### BACKGROUND OF THE INVENTION

Two of the most essential tools utilized in the construction of buildings and other structures are the level and the square. Typically, a level generally comprises an encased, liquid-filled tube having an air bubble that moves to a center window when the instrument is level or set on an even plane. A square typically is a T-shaped or L-shaped instrument for drawing or testing right angles. For instance, a square is often utilized to draw a perpendicular cut line on a construction member.

Previously, it was common to use a level to ensure that a construction member was on an even plane (level with the ground) and then to use a square to ensure that another member or cut was at a ninety degree angle from the first member. However, the need for two separate tools is both cumbersome and inefficient. As a result, level/square combination devices have been designed wherein a square typically has a level built into at least one leg of the square. For relatively close-proximity leveling or squaring, these designs were reasonably sufficient. However, in many construction settings there is a need to align a specified surface or point with a distant surface or point, and/or to create a parallel or perpendicular reference line from a specified surface or point. Consequently, due to the short range capabilities of a level/square combination, such a prior art device, alone, is inadequate.

In an attempt to overcome these deficiencies, a multitude of leveling and guiding tools utilizing laser beams to produce a parallel or perpendicular reference point have been proposed. Examples of such devices may be found by reference to U.S. Pat. No. 5,594,993 to Tager et al., U.S. Pat. No. 5,561,911 to Martin, U.S. Pat. No. 5,531,031 to Green, U.S. Pat. No. 5,144,487 to Hersey, U.S. Pat. No. 3,897,637 to Genho and U.S. Pat. No. D363,679 to Spencer. While these prior art decisions may be laudable, they still allow room for improvement.

For instance, many of the above designs are difficult to use on uneven surfaces. Additionally, the above designs are generally limited to substantially horizontal surfaces and many are not easily adapted for use on tripods.

Accordingly, a new and improved multi-versatile portable level and square laser alignment tool is needed that is very versatile and is capable of being used on horizontal and vertical surfaces. It is thus, to the provision of such an improvement that the present invention is primarily directed.

### SUMMARY OF THE INVENTION

Briefly described, in a first preferred form, the present invention both overcomes the above-mentioned disadvantages, and meets the recognized needs for such device, by providing a portable level and square laser alignment tool comprising generally a base and a separable square. The base serves as an adjustable mounting surface upon which the square is removably secured.

The square preferably comprises two legs positioned at ninety degrees from each other thereby serving as a square to draw and/or test both inside and outside right angles. Preferably, carried on each leg is a bubble level for providing a means to level the L-shaped member and/or the base when used in the attached position. Additionally, a battery powered laser is attached to and in line with each leg via a laser mounting member.

In use, the square can be utilized alone or in conjunction with the base. Via the rotation of any one of a plurality of leveling screws positioned preferably at each corner of the base and extending through the base to the underside of the base, the base may be raised or lowered to compensate for an uneven underlying surface, thus allowing the leveling of the base by observing the bubble level. Once a level base is established, the L-shaped member can be utilized to determine a parallel or perpendicular reference point by activating the respective laser. Because of the characteristics of lasers, perpendicular and/or parallel laser beams may be visible up to 400 yards away.

To provide additional versatility in the present invention, magnets preferably are attached to the base to allow the base to be mounted on a metal wall in a vertical position or any other magnetic surface. Additionally, a tripod throughhole is formed on the bottom of the base to facilitate the connection of the base to a tripod.

Accordingly, it is an object of the present invention to provide a new and improved portable level and square laser alignment tool wherein the level/square tool is separable from the leveling base.

It is another object of the present invention to provide a new and improved portable level and square laser alignment tool that utilizes lasers to create parallel and perpendicular laser beams.

It is yet a further object of the present invention to provide a new and improved portable level and square laser alignment tool having dual bubble-levels.

It is yet a further object of the present invention to provide a new and improved portable level and square laser alignment tool which can having an adjustable base, wherein leveling screws carried at each of corners allow the present invention to be utilized on uneven surfaces.

It is yet a further object of the present invention to provide a new and improved portable level and square laser alignment tool which can be easily attached in a vertical or horizontal position to magnetic surfaces.

It is yet a further object of the present invention to provide a new and improved portable level and square laser alignment tool having 180-degree marking capabilities.

### BRIEF DESCRIPTION OF THE DRAWING FIGURES

The present invention will be better understood by reading the Detailed Description of the Preferred Embodiment with reference to the accompanying drawing figures, in which:

FIG. 1 is a front perspective view of the apparatus according to a preferred embodiment of the present invention shown in a preferred operating position.

FIG. 2 is a front perspective view of the apparatus of FIG. 1 as shown in an alternate operating position.

FIG. 3 is a rear perspective view of the apparatus of FIG. 1.

FIG. 4 is a top view of a base portion of the apparatus of the embodiment of the present invention.

FIG. 5 is a rear side view of the base portion of FIG. 4.

FIG. 6 is a front view of an L-shaped square portion of the apparatus of FIG. 1.

FIG. 7 is a top view of the L-shaped square portion of FIG. 7.

FIG. 8 is a side view of the L-shaped square portion of FIG. 7.

FIG. 9 is a side view of a part of a cam lock assembly of the apparatus of FIG. 1.

FIG. 10 is an end view of the cam lock assembly part of FIG. 9.

FIG. 11 is a perspective view of a cam and the cylindrical shaft of the cam lock assembly of FIG. 1.

FIG. 12 is an end view of a laser mounting bracket portion of the apparatus of FIG. 1.

FIG. 13 is a top view of the laser mounting bracket of FIG. 12.

### DETAILED DESCRIPTION OF THE PREFERRED EMBODIMENT

In describing the preferred and alternate embodiments of the present invention, specific terminology is employed for the sake of clarity. The invention, however, is not intended to be limited to the specific terminology so selected.

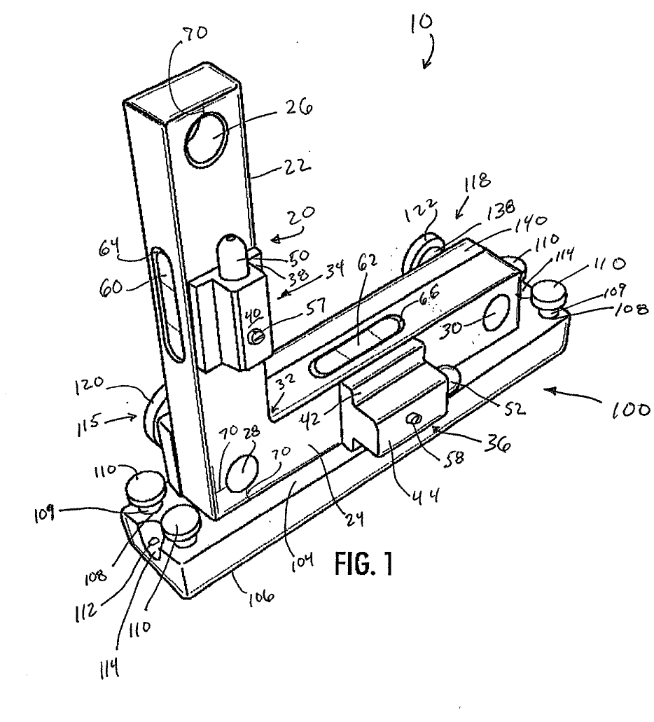

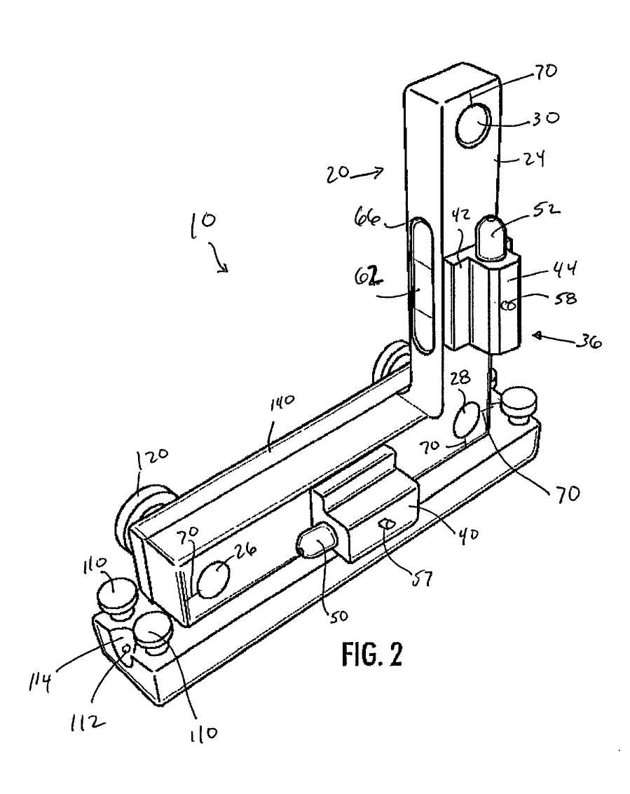

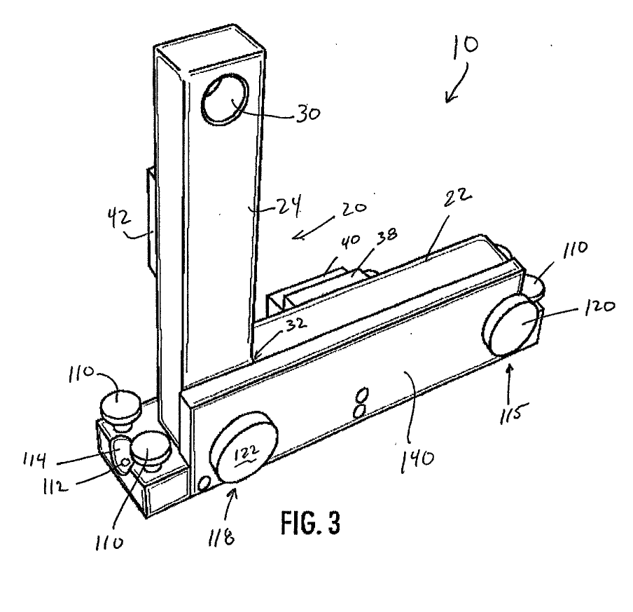

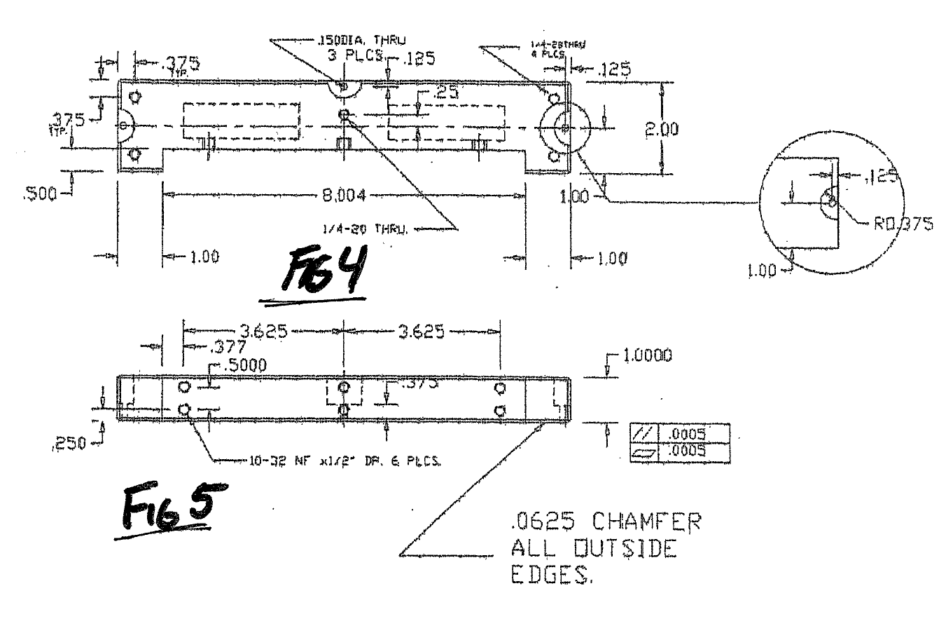

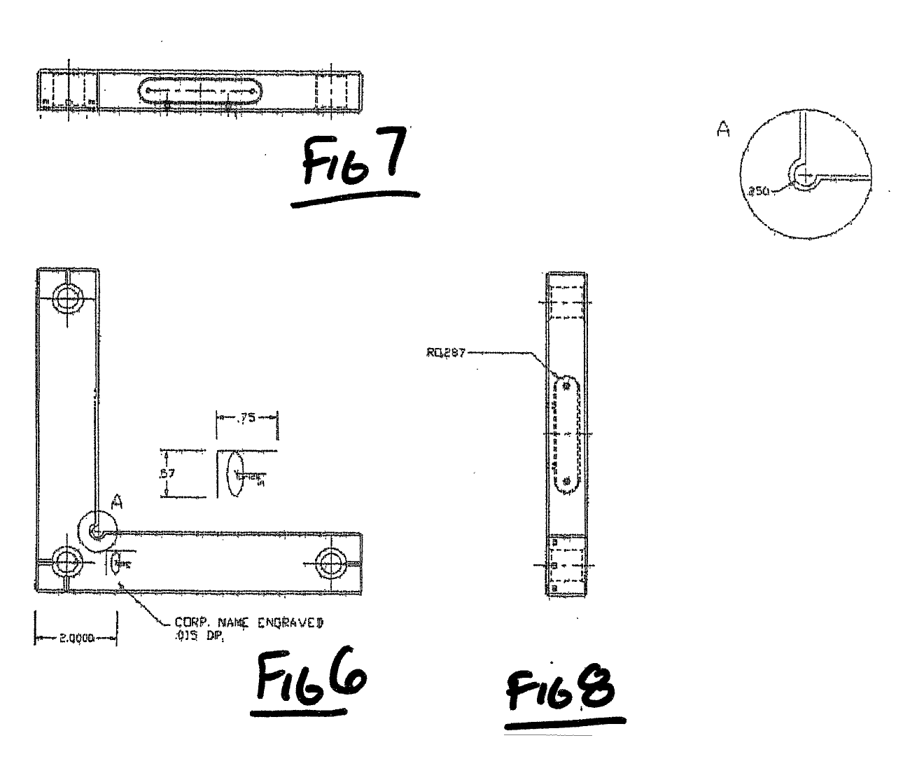

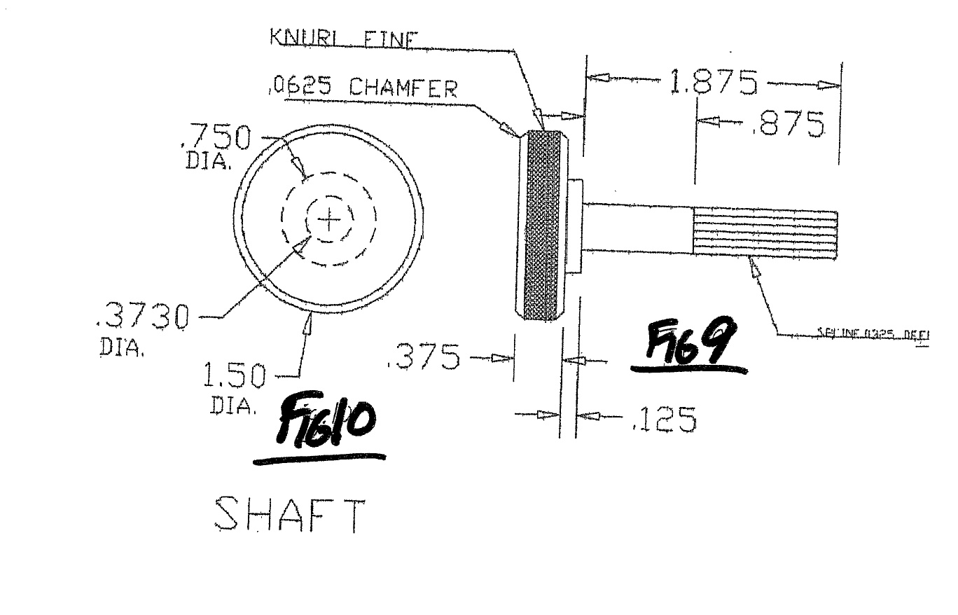

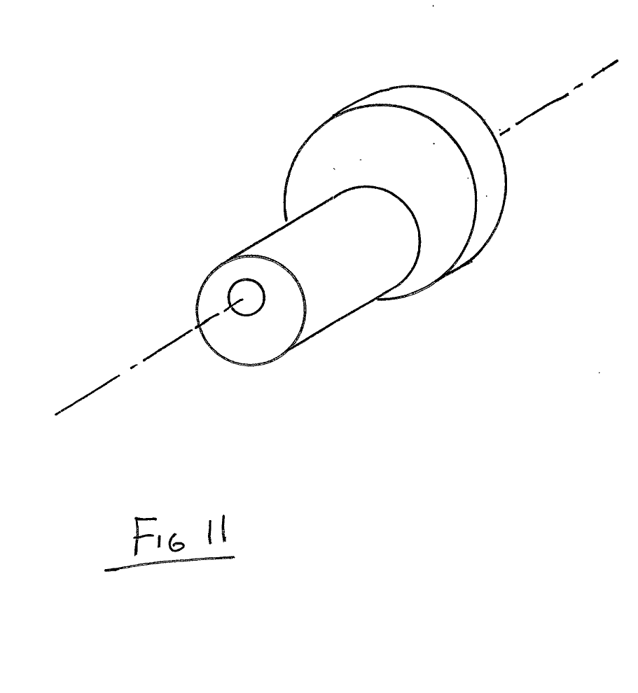

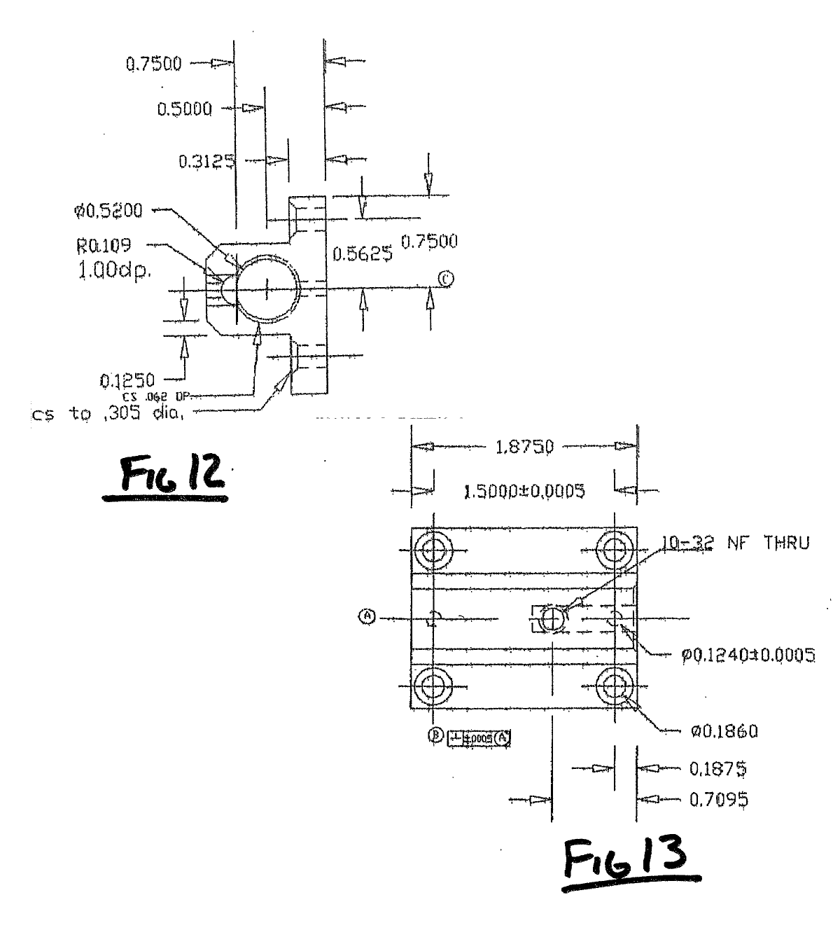

Referring now in detail to the drawing figures, wherein like reference numerals represent like parts throughout the several views, FIGS. 1-13 show a device or apparatus 10 according to a preferred form of the invention. The device 10 generally comprises an L-shaped square 20 and a base 100.

More specifically, base 100 serves as an even leveling surface for mounting L-shaped square 20 thereon, such that base 100 can be adjustably leveled to provide an accurate and stable horizontal or vertical surface for L-shaped square 20, as more fully described below. Base 100 generally comprises an elongated rectangular-shaped horizontal member 102 and an elongated rectangular-shaped vertical member 140. Vertical member 140 is perpendicular to an upper surface 104 of base member 102 along an edge thereof. Vertical member 140 can be formed as an integral part of horizontal member 102, or preferably vertical member 140 and horizontal member 102 can be two separate parts attached together by any one of many well-known securing means such as bolts, rivets or screws.

Preferably, recessed areas 114 are formed at each end of horizontal member 102 and generally centered with each respective end. Approximately centered within recessed areas 114 are throughholes 112 that extend through the bottom surface 106 of horizontal member 102, wherein a bolt, screw or other well-known securing means is inserted therethrough to provide an additional means for securing base 100 to a surface. The recessed areas 114 are provided to ensure that the head of the bolt, screw or other securing means does not interfere with upper surface 104. In an alternate embodiment, additional recessed areas 114 may be formed along the sides of horizontal member 102 to provide additional securing points.

Positioned at approximately the four corners of horizontal member 102 and extending from upper surface 104 to and through bottom surface 106 are threaded bores 108. Bolts 109 are dimensioned to be rotatably engaged within bores 108. Each bolt 109 preferably has a circular head 110 having vertical grooves or other well known gripping means formed on its circumferential side to aid the user in gripping circular head 110. The length of bolts 109 is chosen such that the bolt will extend through horizontal member 102 and past bottom surface 106. Each of bolts 109, via circular heads 110, may be rotated clockwise or counter-clockwise as needed to level base 100. For instance, if the surface upon which base 100 is placed is not level or has surface imperfections, bolts 110 can be independently rotated to raise or lower a given corner to compensate for the uneven underlying surface.

To provide an additional means for securing base 100 to a multitude of surfaces, preferably recessed areas 180 are formed on bottom surface 106 of horizontal member 102 for receiving magnets (not shown) dimensioned to be received therein. The magnets may be secured within recessed areas 180 via any of many well known adhesive materials. As such, base 10 may be secured on a metal wall in a generally vertical position or on a metal table or other magnetically conductive surface. Depending on the weight of device 10, additional recessed areas 180 having additional magnets therein may be utilized to provide adequate support.

To allow device 10 to be operated on a standard tripod platform, a threaded bore 190 is formed preferably at the center of horizontal member 102 in bottom surface 106. Threaded bore 190 is dimensioned for receiving the mounting bolt of a standard tripod.

To provide a means for removably securing L-shaped member 20 to base 100, preferably bores 126, 128 are horizontally formed through vertical member 140 generally proximal to the ends of vertical member 140. Dimensioned to be received within bores 126,128 are sleeves 132,134, respectively. Partially extending through sleeves 132, 134 are cam lock assemblies 115, 118, respectively. Each cam lock assembly 115, 118 preferably comprises circular head portions 120, 122, respectively, elongated cylindrical shafts 136,138, respectively, and cylindrical cams 142, 144, respectively. Preferably, a plurality of indentions or grooves are formed around the circumferential side of circular head portions 120, 122 to provide a gripping means for the user during rotation of circular head portions 120, 122, as more fully described below.

Shafts 136, 138 are formed on and extend generally perpendicular from circular head portions 120, 122, respectively, through sleeves 132,134, respectively, and through and beyond vertical member 140.

Eccentrically fixed to the distal end of shafts 136, 138 are cams 142, 144, respectively. Cams 142,144 are preferably cylindrically shaped and have a diameter greater than bores 126, 128, thus preventing cam lock assembly 115, 118 from inadvertently being removed from bores 126, 128, respectively. There is sufficient radial distance between shafts 136,138 and the internal portion of sleeves 132,134, and sufficient linear distance between cams 142, 144 and vertical member 140 to allow the rotation of circular head portions 120, 122 and thus shafts 136, 138, respectively, and cams 142, 144, respectively. As will be discussed more fully below, cams 142, 144 extend through either first mounting throughhole 26 and second mounting throughhole 28, respectively, or second mounting throughhole 28 and third mounting throughhole 30, respectively, of L-shaped member 20. Because cams 142, 144 are attached off-centered or eccentrically to shafts 136, 138, respectively, when circular head portions 120, 122 are rotated, cams 142, 144 will produce a caming affect on a portion of the radial wall of the respective mounting throughholes 26, 28 or 30, thus producing a frictional wedge to lock L-shaped member 20 to base 100.

L-shaped member 20 generally comprises preferably first leg 22, second leg 24, first laser mounting member 34, second laser mounting member 36, first laser 50, second laser 52, first bubble level 60 and second bubble level 62. First leg 22 and second leg 24 are preferably rectangular shaped. First leg 22 is formed perpendicular with second leg 24, thus forming a squaring device for drawing and testing right angles. All surfaces of first leg 22 and second leg 24 are smooth and on an even plane having small manufacturing tolerances, thereby allowing L-shaped member 20 to be utilized as an accurate inside or outside positioned square. To provide a closer and more accurate alignment of L-shaped member 20 with a given object (i.e., stud, board, joist, etc.) when the given object is positioned between first leg 22 and second leg 24, channel 32 is formed at the inside point of contact between first leg 22 and second leg 24. Preferably, channel 32 is a half-circular cutout portion. In use, one of the corners of an object rest within channel 32 thus allowing the sides of the object to rest substantially flush with first leg 22 and second leg 24, thereby reducing inaccurate measurements caused by flawed corners.

To provide a means for removably attaching L-shaped member 20 to base 100, mounting throughholes 26,30 are formed preferably centered at the distal ends of first leg 22 and second leg 24, respectively, and mounting throughhole 28 is formed preferably centered at the junction between first leg 22 and second leg 24. As discussed above, mounting throughholes 26, 28, 30 are dimensioned for receiving and engaging with cams 142,144 of base 100. More specifically, L-shaped member 20 is slid onto base 100, wherein cam 142 aligns with and is inserted into mounting throughhole 26, and wherein cam 144 aligns with and is inserted into mounting throughhole 26. When circular head portions 120, 122 of base 100 are rotated, cams 142,144, respectively, rotate and cause a counter camming affect within mounting throughholes 26,28, respectively. In other words, cams 142,144 contact the internal walls of mounting throughholes 26, 28, respectively, and urge L-shaped member 20 in the direction of the caming affect; however, each cam 142, 144 within each mounting throughholes 26, 28, restricts movement of L-shaped member 20 thereby resulting in a frictional lock of L-shaped member 20 with base 100. Slight rotation of circular head portions 120, 122 will disengage cams 142, 144 sufficiently to allow L-shaped member 20 to be slid off and removed from base 100. This cam design allows for a quick and easy means for separating or securing L-shaped member 20 with base 100, thus allowing L-shaped member 20 to be utilized with or without base 100 as desired by the user. In an alternate mode of operation, L-shaped member 20 may be rotated ninety degrees, wherein cam 142 aligns with and is inserted into mounting throughhole 28, and wherein cam 144 aligns with and is inserted into mounting throughhole 30.

Preferably mounted on the same side of first leg 22 and second leg 24 are first laser mounting member 34 and second laser mounting member 36, respectively. First laser mounting member 34 and second laser mounting member 36 serve as a securing mount for lasers 50, 52, respectively. First laser mounting member 34 and second laser mounting member 36 preferably comprise rectangular-shaped mounting platforms 38, 42, respectively, and securing blocks 40, 44, respectively, formed thereon. Mounting platforms 38, 42 have a width equal to or less than the width of first leg 22 and second leg 24, respectively, to prevent mounting platforms 38, 42 from interfering with operation of device 10. Mounting platforms 38, 42 are preferably secured approximately at the center of each respective leg via four known and widely available hex head bolts positioned proximal to each of the four corners of mounting platforms 38, 42. It should be noted that one skilled in the art will recognize that additional means for securing mounting platforms 38, 42 to the respective leg may be utilized.

Extending perpendicular from mounting platforms 38,42 are securing blocks 40, 44, respectively. Securing blocks 40, 44 are preferably cylindrically-shaped blocks having a bore formed therethrough at the center of each securing block 40, 44. Each bore is dimensioned for snugly receiving a laser 50, 52. Lasers 50, 52 are preferably well known and widely available battery-powered hand-held cylindrically-shaped lasers having an activation button extending slightly past the circumferential exterior wall of lasers 50, 52, wherein lasers 50, 52 are activated by pressing and holding the activation button (such lasers are typically of the class IIIa laser diode type capable of beam ranges up to 400 yards). To allow the insertion of lasers 50, 52 into the bores of securing block 40, 44, respectively, without inadvertently pressing the respective activation button and thus inadvertently activating the laser, preferably half-circular channels 54, 56, respectively, dimensioned for receiving the activation button is formed longitudinally within each bore. Channels 54, 56 are preferably located such that the respective activation buttons are positioned directly opposite mounting platforms 38, 42, respectively. Additionally, channels 54, 56 are formed only partially along the length of securing blocks 40, 44, respectfully, such that the end of channels 54, 56 serve as a seating surface or stop for the activation button. As such, knobs 57,58 are threaded through a threaded bore formed directly aligned with the end of channels 54,56, respectively, and thus are perpendicular and aligned with the respective activation buttons. Additionally, lasers 50, 52 are positioned such that the laser light emitted projects parallel with first leg 22 and second leg 24, respectively, and away from second mounting throughhole 28. To activate lasers 50, 52, knobs 57, 58, respectively, are rotated clockwise until knobs 57, 58 press against the respective activation buttons. To deactivate lasers 50, 52, knobs 57, 58, respectively are rotated counter-clockwise until knobs 57, 58 cease pressing against the respective activation button.

First bubble level 60 and second bubble level 62 are attached to first leg 22 and second leg 24, respectively, to provide a means for leveling device 10. Recessed areas 64, 66 are formed in first leg 22 and second leg 24, respectively, for receiving first bubble level 60 and second bubble level 62, respectively, wherein first bubble level 60 and second bubble level 62 are inline with first leg 22 and second leg 24, respectively. First bubble level 60 and second bubble level 62 are secured within the respective recessed areas via screws, bolts or any other well known securing means. Preferably, recessed area 64 is formed on the inside wall of first leg 22, and recessed area 66 is formed on the outside wall of second leg 24, such that when L-shaped member 20 is utilized in its preferred position (i.e., cam 142 secured within second mounting throughhole 28 and cam 144 secured within third mounting throughhole 30), both first bubble level 60 and second bubble level 62 may be observed by the user. First bubble level 60 and second bubble level 62 are well known and widely available bubble-type levels.

To provide an additional alignment means, alignment grooves 70 are formed on the ends of each leg 22, 24, wherein alignment grooves 70 are parallel with the respective leg 22, 24. Alignment grooves 70 may be utilized as a sight reference marker or as an alignment reference marker for lasers 50, 52, wherein alignment grooves 70 are inline with the respective lasers 50, 52 thus creating a means for marking an initial reference point.

To ensure the accuracy of device 10, in the preferred form, all edges of device 10 are chamfered and all surfaces are flat. Additionally, all angles and portions of device 10 are precision machined with preferably zero tolerance. It should be noted that aluminum is the preferred material for device 10; however, a multitude of other known materials may be utilized, such as, for exemplary purposes only, plastic, wood, graphite composite, other metals and other composite-type material. The material however must be rigid to prevent deflection during use and thus, inaccurate measurements.

Having thus described the preferred forms of the present invention, those skilled in the art will additionally recognize that the within disclosures are exemplary only, and that various other alternatives, adaptations, and modifications may be made within the spirit and scope of the present invention as set forth in the following claims.

What is claimed is:

1. A leveling combination squaring tool, comprising:
a base;
an L-shaped square removably mounted to said base, said L-shaped square having a first leg and a second leg, said first leg being perpendicular to said second leg such that said L-shaped square can be utilized to determine right angles;
at least one bubble level mounted to said L-shaped square;
at least one laser mounted to said L-shaped square, wherein said laser projects a visible beam representing a parallel or perpendicular reference point a distance from said L-shaped square;
a first rotatable cam mounted to said base; and
a second rotatable cam mounted to said base and spaced apart from said first rotatable cam, wherein said first rotatable cam and said second rotatable cam each can engage said L-shaped square to urge said L-shaped square against said base.

2. The tool of claim 1, further comprising leveling means mounted to said base for adjusting the inclination of said base.

3. The tool of claim 2, wherein said leveling means comprises a plurality of threaded leveling feet.

4. The tool of claim 1, further comprising at least one magnet mounted to said base for mounting said base to a magnetic surface.

5. A combination leveling and squaring tool, comprising:
a base;
a square for determining inside and outside right angles, said square being removably mounted to said base;
a level indicator mounted to said square for determining whether a portion of said square is level; and
at least one laser mounted to said square wherein said laser projects a visible beam representing a parallel or perpendicular reference point a distance from said square.

6. The tool of claim 5, wherein said square is L-shaped.

7. The tool of claim 5, wherein said level indicator comprises at least one bubble level.

8. The tool of claim 5, further comprising leveling feet mounted to said base for adjusting the inclination of said base.

9. The tool of claim 8, wherein said leveling feet comprise a plurality of leveling screws, and wherein said leveling screws are threaded to said base.

10. The tool of claim 5, further comprising a first rotatable cam mounted to said base and a second rotatable cam mounted to said base, wherein said second rotatable cam is spaced apart from said first rotatable cam, and wherein said first rotatable cam and said second rotatable cam engage said square, and, when rotated in one direction, urge said square against said base.

11. The tool of claim 5, further comprising at least one magnet mounted to said base for temporarily securing said base to a magnetic surface.

12. The tool as claimed in claim 6 wherein said L-shaped square has perpendicular inside surfaces for determining the squareness of an outside corner and perpendicular outside surfaces for determining the squareness of an inside corner.

13. The tool as claimed in claim 12 wherein said at least one laser is mounted to said square at a surface other than said perpendicular inside surfaces and other than said perpendicular outside surfaces.

14. A combination leveling and squaring tool, comprising:
a base;
an L-shaped square removably mounted to said base, said L-shaped square having a first leg and a second leg, said first leg being perpendicular to said second leg such that said L-shaped square is utilized to determine right angles;
at least one bubble level mounted to said L-shaped square; and
at least one laser mounted to said L-shaped square, wherein said at least one laser produces a visible beam representing a parallel or perpendicular reference point a distance from said L-shaped square.

15. The tool of claim 14, further comprising leveling feet mounted to said base for adjusting the inclination of said base.

16. The tool of claim 15, wherein said leveling feet comprise a plurality of leveling screws, wherein said leveling screws are threaded to said base and wherein said leveling screws can be rotated to adjust the inclination of said base.

17. The tool of claim 14, further comprising a first rotatable cam and a second rotatable cam each mounted to said base, wherein said second rotatable cam is spaced apart from said first rotatable cam, and wherein said first rotatable cam and said second rotatable cam each are adapted to engage said L-shaped square and to urge said L-shaped square against said base.

18. The tool of claim 14, further comprising at least one magnet mounted to said base for mounting said base to a magnetic surface.
